(19) United States
(12) Patent Application Publication
(10) Pub. No.: US 2020/0317352 A1
(43) Pub. Date: Oct. 8, 2020

(54) REUSE OF WASTE OXYGEN ENRICHED AIR IN AN AIRCRAFT

(71) Applicant: The Boeing Company, Chicago, IL (US)

(72) Inventors: Can Onur, Munich (DE); Maxim Constantijn Vos, Madrid (ES)

(21) Appl. No.: 16/376,532

(22) Filed: Apr. 5, 2019

(51) Int. Cl. B64D 13/06; B64D 13/02; B01D 53/22

(52) U.S. Cl. CPC B64D 13/06; B64D 13/02; B64D 2013/0681; B64D 2231/025; B01D 53/22

(57) ABSTRACT

Aircrafts and methods for reusing oxygen enriched air. In one embodiment, an aircraft includes an oxygen supply subsystem configured to supply oxygen to a cabin of the aircraft, and an air separator configured to receive a pressurized air stream, to separate the pressurized air stream into oxygen enriched air and an inert gas, and to feed the oxygen enriched air to the oxygen supply subsystem.

### FIELD

This disclosure relates to the field of aircraft, and more particularly, to oxygen delivery on an aircraft.

### BACKGROUND

Some aircraft include an Environmental Control System (ECS) that supplies oxygen, thermal control, and cabin pressurization for the crew and passengers. In an ECS, air is compressed to high pressure and temperature, such as with bleed air from the compressor stage of an engine. The compressed air is fed to an Environmental Control Unit (ECU) via a flow control valve, where the air is conditioned by heat exchangers and an Air-Cycle Machine (ACM), if needed, that cools the air to a desired temperature. The conditioned air is then delivered to the cabin and cockpit at the desired temperature and pressure.

A pressurized aircraft also includes an emergency oxygen system that activates in the event that the cabin becomes depressurized. For a typical emergency oxygen system, oxygen masks will automatically deploy above or in front of the passenger seats and crew seats. Oxygen is supplied to the masks with a chemical oxygen generator or a gaseous manifold system. The chemical oxygen generator uses an exothermic reaction (e.g., igniting a mixture of sodium chlorate and iron powder) to create a supply of oxygen. The gaseous manifold system uses one or more tanks of oxygen, usually stored in the cargo hold, to supply the oxygen.

It may be desirable to identify other ways of supplying or supplementing oxygen to an ECS, the emergency oxygen system, or other subsystems of an aircraft.

### SUMMARY

Embodiments described herein reuse oxygen enriched air from an inerting system and/or a stand-alone air separator for one or more subsystems of an aircraft. An inerting system or air separator operates by separating a pressurized air stream into oxygen enriched air and an inert gas (e.g., nitrogen). In a traditional aircraft that uses an inerting system, the inert gas is fed to a fuel tank to safeguard against fire or explosion, while the oxygen enriched air is dumped through a ram duct. In the embodiments described herein, the oxygen enriched air is fed to an ECS, an emergency oxygen system, and/or another subsystem of the aircraft. Thus, the oxygen enriched air is not wasted, but is reused by another system of the aircraft.

One embodiment comprises an aircraft that includes an oxygen supply subsystem configured to supply oxygen to a cabin of the aircraft, and an air separator configured to receive a pressurized air stream, to separate the pressurized air stream into oxygen enriched air and an inert gas, and to feed the oxygen enriched air to the oxygen supply subsystem.

In another embodiment, the air separator is part of an inerting system configured to feed the inert gas to a fuel tank of the aircraft.

In another embodiment, the oxygen supply subsystem comprises an emergency oxygen system, and the air separator is configured to feed the oxygen enriched air to the emergency oxygen system.

In another embodiment, the aircraft further includes a pressure sensor configured to detect a cabin decompression event on the aircraft, and a manifold configured to feed the oxygen enriched air from the air separator to the emergency oxygen system in response to the cabin decompression event.

In another embodiment, the emergency oxygen system includes masks configured to automatically deploy in response to the cabin decompression event.

In another embodiment, the emergency oxygen system includes outlet vents configured to supply oxygen to particular regions within the cabin in close proximity to seats in response to the cabin decompression event.

In another embodiment, the oxygen supply subsystem comprises an air distribution subsystem, and the air separator is configured to feed the oxygen enriched air to the air distribution subsystem.

In another embodiment, the aircraft further includes a pressure sensor configured to detect a cabin decompression event on the aircraft, and a manifold configured to feed the oxygen enriched air from the air separator to the air distribution subsystem in response to the cabin decompression event.

In another embodiment, the aircraft further includes an oxygen sensor configured to measure oxygen content at the oxygen supply subsystem, and a regulator configured to regulate the oxygen enriched air fed to the oxygen supply subsystem based on the oxygen content.

In another embodiment, the pressurized air stream comprises bleed air from an engine of the aircraft.

In another embodiment, the pressurized air stream comprises compressed air from a compressor on the aircraft.

Another embodiment comprises an aircraft that includes an emergency oxygen system configured to automatically supply oxygen to a cabin of the aircraft when a cabin altitude exceeds a threshold. The aircraft further includes an inerting system configured to receive a pressurized air stream, to separate the pressurized air stream into oxygen enriched air and nitrogen enriched air, and to feed the nitrogen enriched air to a fuel tank of the aircraft. The aircraft further includes a manifold configured to feed the oxygen enriched air from the inerting system to the emergency oxygen system when the cabin altitude exceeds the threshold.

In another embodiment, the aircraft further comprises an air distribution subsystem configured to distribute conditioned air through the cabin via one or more overhead ducts. The manifold is configured to feed the oxygen enriched air from the inerting system to the air distribution subsystem when the cabin altitude is below the threshold.

In another embodiment, the aircraft further includes an oxygen sensor configured to measure oxygen content in the emergency oxygen system and/or the air distribution subsystem, and a regulator configured to regulate the oxygen enriched air fed to the emergency oxygen system and/or the air distribution subsystem based on the oxygen content.

Another embodiment comprises a method of supplying oxygen enriched air to an aircraft. The method comprises receiving a pressurized air stream at an air separator on an aircraft, separating the pressurized air stream into oxygen enriched air and nitrogen enriched air at the air separator, feeding the nitrogen enriched air to a fuel tank of the aircraft, detecting a cabin decompression event on the aircraft, and feeding the oxygen enriched air to an emergency oxygen system in response to the cabin decompression event.

In another embodiment, the method further comprises feeding the oxygen enriched air to an air distribution subsystem of the aircraft when a cabin decompression event is not detected.

In another embodiment, the method further comprises measuring oxygen content in the emergency oxygen system and/or the air distribution subsystem, and regulating the oxygen enriched air fed to the emergency oxygen system and/or the air distribution subsystem based on the oxygen content.

In another embodiment, the method further comprises feeding the oxygen enriched air to an air distribution subsystem of the aircraft in response to the cabin decompression event.

The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments of the present invention are now described, by way of example only, with reference to the accompanying drawings. The same reference number represents the same element or the same type of element on all drawings.

FIG. 1 depicts a side view of an aircraft in an illustrative embodiment.

FIG. 2 is a schematic diagram of an aircraft in an illustrative embodiment.

FIG. 3 is a schematic diagram of an ECU in an illustrative embodiment.

FIG. 4A illustrates an air distribution subsystem in an illustrative embodiment.

FIG. 4B is a cross-sectional view of an aircraft in an illustrative embodiment.

FIG. 5 is a schematic diagram of an inerting system in an illustrative embodiment.

FIG. 6 is a schematic diagram of an aircraft in another illustrative embodiment.

FIG. 7 is a schematic diagram of an aircraft in another illustrative embodiment.

FIG. 8 is a schematic diagram of an aircraft in another illustrative embodiment.

FIG. 9 is a flow chart illustrating a method of supplying oxygen enriched air to an aircraft in an illustrative embodiment.

FIG. 10 is a flow chart illustrating another method of supplying oxygen enriched air to an aircraft in an illustrative embodiment.

### DETAILED DESCRIPTION

The figures and the following description illustrate specific exemplary embodiments. It will be appreciated that those skilled in the art will be able to devise various arrangements that, although not explicitly described or shown herein, embody the principles described herein and are included within the contemplated scope of the claims that follow this description. Furthermore, any examples described herein are intended to aid in understanding the principles of the disclosure, and are to be construed as being without limitation. As a result, this disclosure is not limited to the specific embodiments or examples described below, but by the claims and their equivalents.

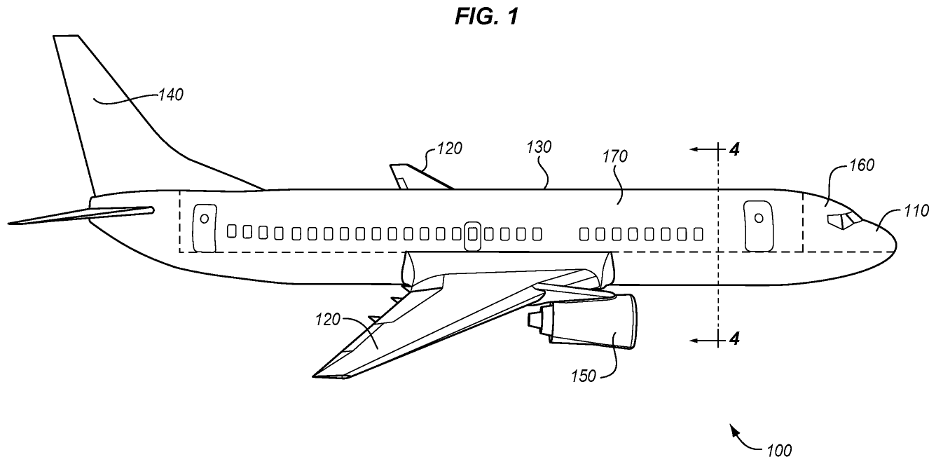

FIG. 1 depicts a side view of an aircraft 100 in an illustrative embodiment. Aircraft 100 includes a nose 110, wings 120, a fuselage 130, a tail 140, and engines 150. Within fuselage 130 is a cockpit 160 and a cabin 170. Cockpit 160 (or flight deck) is the section or area from which pilots control aircraft 100, and includes the flight controls and flight instruments. Cabin 170 is the section or area where passengers travel, and includes rows of seats. Although aircraft 100 has been depicted to have a particular configuration for purposes of discussion, aircraft 100 may have other configurations in other embodiments.

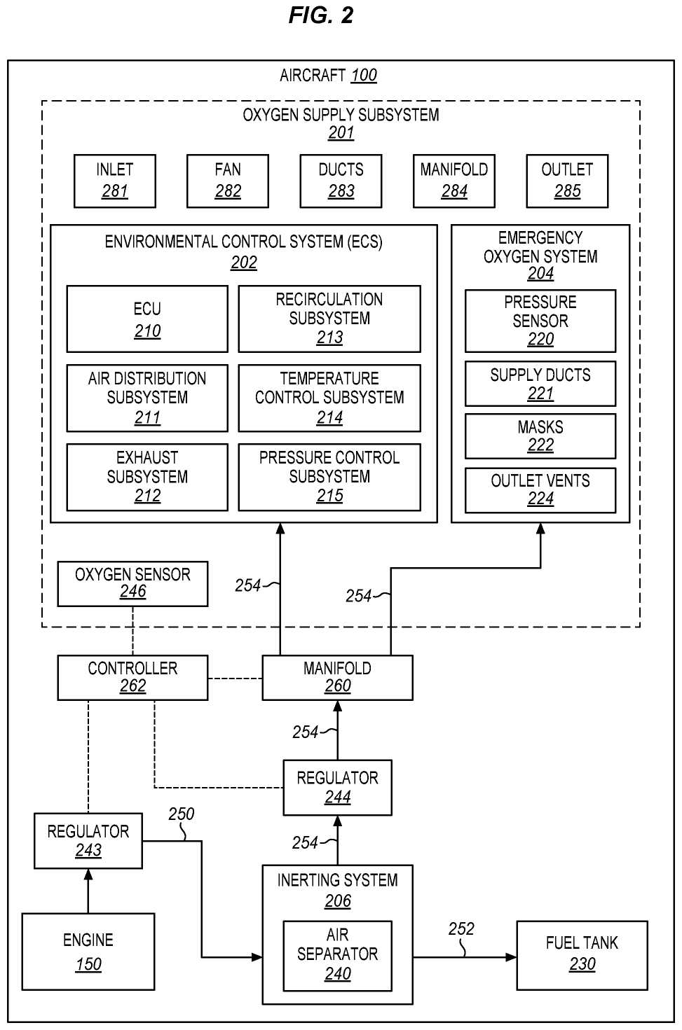

FIG. 2 is a schematic diagram of aircraft 100 in an illustrative embodiment. It is assumed in this embodiment that aircraft 100 is pressurized. Thus, aircraft 100 includes one or more oxygen supply subsystems 201 that are configured to supply, convey, or deliver oxygen to crew members and/or passengers within cockpit 160 and/or cabin 170. An oxygen supply subsystem 201 may have a variety of structures to delivery oxygen, which may include one or more of the following: one or more inlets 281 configured to receive a supply of oxygen, one or more fans 282 to create or control an airflow that includes the oxygen, one or more ducts 283 configured to convey an airflow to locations of cockpit 160 and/or cabin 170, one or more manifolds 284 configured to direct airflows to ducts 283 and/or control flow rate, one or more outlets 285 (e.g., outlet vents, masks, etc.) configured to release an airflow into cockpit 160 and/or cabin 170, and/or other components such as piping, hoses, etc. The structure of an oxygen supply subsystem 201 may vary depending on the type of subsystem. One example of an oxygen supply subsystem 201 is an ECS 202. ECS 202 is a system responsible for supplying air, pressurizing and ventilating cabin 170, controlling temperature, and other tasks. In this embodiment, ECS 202 includes an Environmental Control Unit (ECU) 210, an air distribution subsystem 211, an exhaust subsystem 212, a recirculation subsystem 213, a temperature control subsystem 214, and a pressure control subsystem 215. The configuration of ECS 202 is an example, and ECS 202 may include more or less subsystems in other embodiments.

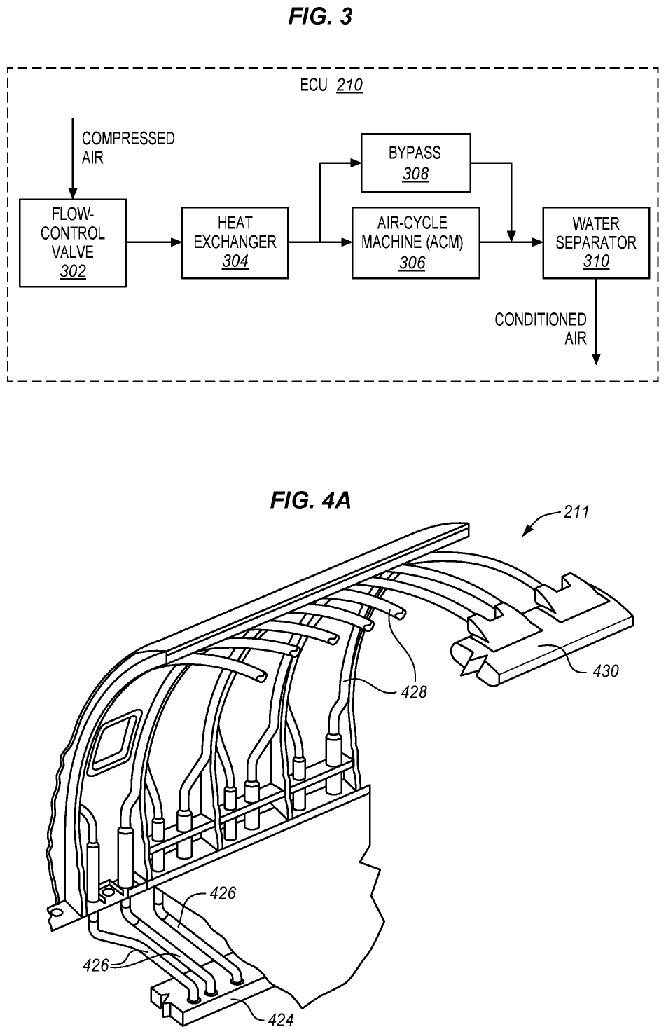

ECU 210 is configured to condition air that is supplied to cockpit 160 and/or cabin 170. FIG. 3 is a schematic diagram of ECU 210 in an illustrative embodiment. ECU 210 includes a flow control valve 302, one or more heat exchangers 304, an Air-Cycle Machine (ACM) 306, a bypass 308, and a water separator 310. Flow control valve 302 receives compressed air, and regulates the amount of compressed air that enters cabin 170. Flow control valve 302 may receive the compressed air (i.e., bleed air) from one or more compressor stages of an engine 150 when aircraft 100 is in flight. Flow control valve 302 may receive the compressed air from an auxiliary power unit (APU), a ground cart (GCU), airport high-pressure hydrants, etc., when aircraft 100 is on the ground. The compressed air passing through flow control valve 302 travels through heat exchanger(s) 304, where it is cooled by outside air to a desired temperature. At cruising altitude where the outside air is cold, the compressed air may be cooled sufficiently by heat exchanger(s) 304 and does not need further cooling by ACM 306. Thus, the compressed air travels through bypass 308 instead of through ACM 306. At lower altitudes or on the ground, the compressed air may be further cooled by traveling through ACM 306, which includes one or more air conditioning packs. The compressed air then travels through water separator 310, which controls the moisture level of the air. The air leaving ECU 210 is “conditioned air”, that is fed to air distribution subsystem 211 (see FIG. 2). The configuration of ECU 210 is an example, and ECU 210 may include more or less elements in other embodiments.

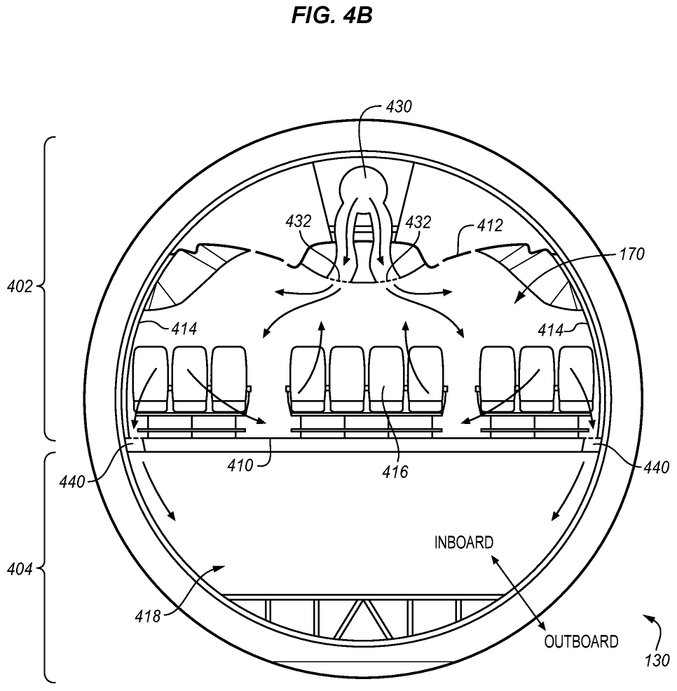

In FIG. 2, air distribution subsystem 211 is configured to distribute the conditioned air from ECU 210 to cockpit 160 and cabin 170. Air distribution subsystem 211 may distribute the conditioned air to different zones of aircraft 100, and each zone may have its own ducting system to provide independent temperature control for each zone. For example, a narrow-body aircraft may have two zones; one for cockpit 160 and one for cabin 170. A wide-body aircraft may have multiple zones for cabin 170 that are each independently temperature controlled (e.g., one for first class, one for business class, and one for economy). Exhaust subsystem 212 (which may be considered part of air distribution subsystem 211) removes air from cockpit 160 and cabin 170. Air is generally exhausted from cabin 170 through floor-level grilles or exhaust vents that run the length of cabin 170 on both sides along a sidewall. FIG. 4A illustrates an air distribution subsystem 211 in an illustrative embodiment. Distribution of air is managed with a system of air ducts throughout cabin 170. Typically, air is ducted to and released from overhead vents, where it circulates and flows out floor-level exhaust vents. Ducting is hidden below the cabin floor and behind walls and ceiling panels depending on the aircraft. In this example, air distribution subsystem 211 may include a mixing manifold 424, one or more riser ducts 426, one or more overhead supply ducts 428, one or more overhead ducts 430, and one or more outlet vents or overhead vents, which is not visible in FIG. 4A. Although not shown, air distribution subsystem 211 may further include recirculation filters, one or more fans, plenum assemblies, etc.

FIG. 4B is a cross-sectional view of aircraft 100 in an illustrative embodiment. The view in FIG. 4B is across cut plane 4-4 in FIG. 1. Fuselage 130 includes an upper section 402, which includes a floor 410, a ceiling 412, and sidewalls 414 that form cabin 170, which includes seats 416 for the passengers. Fuselage 130 also includes a lower section 404, which includes a cargo area 418. FIG. 4B further illustrates an outboard direction that proceeds towards an external surface of aircraft 100, and an inboard direction that proceeds towards the interior (e.g., cabin 170) of aircraft 100.

Air distribution subsystem 211 includes overhead duct 430 that delivers conditioned air through cabin 170 or through one or more zones of cabin 170. There may be more or less overhead ducts 430 for air distribution subsystem 211 than is shown in FIG. 4B, and the overhead ducts 430 may be positioned in different locations in other embodiments. Airflow is released from overhead duct 430 into cabin 170 through one or more outlet vents 432. Although outlet vents 432 are shown as overhead vents in this example, outlet vents 432 may be disposed at different locations as desired. The arrows in FIG. 4B illustrate how the conditioned air circulates through cabin 170. Air is released from outlet vents 432 and circulates through cabin 170. The air is evacuated from cabin 170 through grills or exhaust vents 440. The exhaust air may be directed alongside or through the cargo area 418, where it may provide some heating or cooling. The exhaust air is then exhausted outboard through outflow valves (not shown) controlled to maintain the desired cabin pressure.

In FIG. 2, recirculation subsystem 213 is an optional system that recycles some exhaust air back into cabin 170 or back to ECU 210. Temperature control subsystem 214 is configured to control ECU 210 to discharge conditioned air at a desired temperature. Pressure control subsystem 215 controls the rate of change of cabin pressure during climb and descent of aircraft 100, and establishes the cabin pressure at cruising altitude to create a safe environment in cabin 170. The pressure inside cabin 170 is equivalent to an altitude, so the cabin pressure is referred to as a “cabin altitude”. For example, if the pressure of the cabin is about 11 lbs/in², then the cabin altitude is about 7,000 feet. This pressure is equivalent to what a human would experience if he/she were at an elevation of 7,000 feet. The maximum cabin altitude allowed by transport category aircraft regulations is 8,000 feet, so pressure control subsystem 215 attempts to maintain the pressure inside cabin 170 below that altitude during normal operation.

Another example of an oxygen supply subsystem 201 is an emergency oxygen system 204. Emergency oxygen system 204 is configured to supply oxygen to crew members and passengers in response to a loss of pressurization of cabin 170, which is referred to as a cabin depressurization event. Emergency oxygen system 204 includes a pressure sensor 220, which comprises a sensor configured to measure the pressure inside of cabin 170 and/or cockpit 160 of aircraft 100. Pressure sensor 220 is configured to detect a cabin decompression event on aircraft 100. For example, if the cabin altitude reaches or exceeds a threshold (e.g., 10,000 feet), then pressure sensor 220 may detect a cabin decompression event. Emergency oxygen system 204 may further include supply ducts 221, masks 222, and/or outlet vents 224. Masks 222 are configured to automatically deploy in response to a cabin decompression event, and includes a facial cup and elastic bands for securing mask 222 to the face of a passenger or crew member. Outlet vents 224 may be used in place of or in addition to masks 222 to supply oxygen to particular regions within cabin 170, such as in close proximity to seats 416 of aircraft 100. In one embodiment, outlet vents 224 of emergency oxygen system 204 may include the outlet vents 432 of air distribution subsystem 211. In other embodiments, additional outlet vents 224 may be installed in close proximity to seats 416 (i.e., overhead or directly in front of seats 416) to provide an airflow directly toward passengers. Emergency oxygen system 204 is configured to automatically supply oxygen to cabin 170 through masks 222 and/or outlet vents 224 when the cabin altitude exceeds a threshold. Although not shown, emergency oxygen system 204 may further include one or more fans, one or more manifolds, hoses, piping, etc.

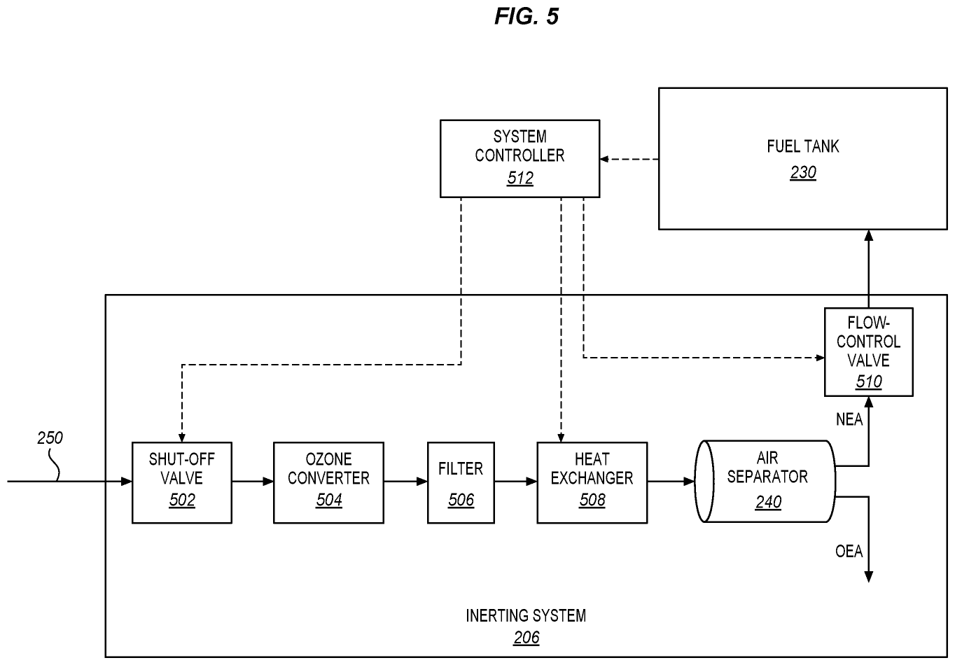

In the embodiments described herein, oxygen enriched air is provided to one or more of the oxygen supply subsystems 201 via an air separator. As shown in FIG. 2, aircraft 100 may further include an inerting system 206. Inerting system 206 is part of a Flammability Reduction System (FRS) for aircraft 100. FRS may be considered part of ECS 202, but is shown outside of ECS 202 in this embodiment. Inerting system 206 is configured to decrease the probability of combustion of flammable materials stored in a fuel tank 230 of aircraft 100 by replacing the air in fuel tank 230 with an inert gas, such as nitrogen, nitrogen enriched air, steam, carbon dioxide, etc. Inerting system 206 feeds an inert gas into the ullage of fuel tank 230, which reduces the oxygen concentration of the ullage to below the combustion threshold. Thus, flammable vapors in fuel tank 230 are rendered inert, and will not ignite in the presence of an ignition source. Inerting system 206 includes an air separator 240 (also referred to as an air separation module), which is configured to separate a pressurized air stream into an inert gas (e.g., nitrogen enriched air (NEA)) and oxygen enriched air (OEA). In one embodiment, air separator 240 may use fiber membranes to remove oxygen from a pressurized air stream, and generate nitrogen enriched air that is distributed to fuel tank 230. Inerting system 206 also includes other components, one of example of which is shown in FIG. 5

FIG. 5 is a schematic diagram of inerting system 206 in an illustrative embodiment. Inerting system 206 receives pressurized air stream 250 through a shut-off valve 502. Pressurized air stream 250 travels through ozone (O3) converter 504, which is a catalytic converter that converts triatomic oxygen (ozone) to biatomic or “regular” oxygen to protect other elements in inerting system 206 from oxidation. Pressurized air stream 250 then travels through one or more filters 506 to a heat exchanger 508, which cools the pressurized air stream 250. For instance, bleed air is really hot when it comes off engine 150, and heat exchanger 508 cools the bleed air to protect other elements of inerting system 206 and increase their effectiveness. Pressurized air stream 250 then travels to air separator 240, which physically separates an inert gas (e.g., nitrogen (N2)) in the air. This separation may be accomplished by running the pressurized air stream 250 through semipermeable fibrous tubes. Because almost all of the non-N2 molecules present are smaller than the N2 molecules, those smaller molecules pass through the membranes as oxygen enriched air (OEA); leaving the nitrogen enriched air (NEA) that is fed to fuel tank 230 through a flow-control valve 510. A system controller 512 receives sensor inputs to control operation of flow-control valve 510, shut-off valve 502, heat exchanger 508, and/or other elements.

In the embodiment shown in FIG. 2, air separator 240 receives the pressurized air stream 250 from an engine 150 of aircraft 100 as bleed air. In a Boeing 737 or 777, for example, bleed air from an engine may be fed to air separator 240 of inerting system 206. A regulator 243 (e.g., including a flow control valve) may be installed upstream from inerting system 206 to control or regulate the bleed air that is fed to air separator 240. Air separator 240 separates the pressurized air stream 250 into an inert gas 252 and oxygen enriched air 254. Air separator 240 feeds the inert gas 252 to fuel tank 230, and feeds the oxygen enriched air 254 to an oxygen supply subsystem 201 through a regulator 244.

Regulator 244 is configured to control or regulate the oxygen enriched air 254 that is fed to an oxygen supply subsystem 201. An oxygen sensor 246 is configured to measure oxygen content or an oxygen level in an oxygen supply subsystem 201. For example, oxygen sensor 246 may measure the oxygen content in air distribution subsystem 211, emergency oxygen system 204, etc. Oxygen sensor 246 is configured to provide a signal to regulator 244 and/or a controller 262 indicating the oxygen content. Controller 262 is configured to determine how much oxygen enriched air 254 to supply to oxygen supply subsystem 201 based on the oxygen content measured by oxygen sensor 246, and control regulator 244 accordingly. Thus, aircraft 100 includes a closed-loop system for supplying oxygen enriched air 254 to an oxygen supply subsystem 201.

Regulator 244 may feed the oxygen enriched air 254 directly to an oxygen supply subsystem 201, such as to air distribution subsystem 211, emergency oxygen system 204, and/or another subsystem. In this embodiment, regulator 244 may feed the oxygen enriched air 254 to a manifold 260, which is configured to control where the oxygen enriched air 254 is fed. Manifold 260 is coupled to controller 262, which is configured to control manifold 260 in response to input from pressure sensor 220 and/or other devices or instruments. For example, manifold 260 may direct the oxygen enriched air 254 to air distribution subsystem 211 under normal operating conditions (e.g., cabin altitude is below a threshold), may direct the oxygen enriched air 254 to air distribution subsystem 211 in response to a cabin decompression event (e.g., the cabin altitude is above a threshold), may direct the oxygen enriched air 254 to emergency oxygen system 204 in response to a cabin decompression event, or may direct the oxygen enriched air 254 to both or other subsystems. Controller 262 may also control regulators 243-244 or other devices, and may receive input from pressure sensor 220, oxygen sensor 246, and/or other devices or instruments.

In the embodiment described above, the oxygen enriched air 254 from inerting system 206 is advantageously reused for air distribution subsystem 211, emergency oxygen system 204, and/or another subsystem. In a traditional aircraft, the oxygen enriched air 254 from an inerting system was dumped out a ram duct and wasted. The embodiment described above uses the oxygen enriched air 254 from inerting system 206 in an effective manner for other subsystems of aircraft 100. For example, the oxygen enriched air 254 may be fed to emergency oxygen system 204 (or possibly to air distribution subsystem 211) as an oxygen supply during a cabin decompression event, which replaces traditional emergency systems (i.e., a chemical oxygen generator or gaseous manifolds). One technical benefit is that emergency oxygen system 204 has an unlimited oxygen supply as long as aircraft 100 is airborne, where traditional emergency systems had limited supplies (e.g., fifteen to twenty minutes). Another benefit is that traditional emergency systems do not need to be installed on aircraft 100, which may reduce the weight of aircraft 100. Another benefit is that a chemical oxygen generator uses an exothermic reaction, which may be a fire risk and may produce unhealthy vapors. Yet another benefit is that the oxygen supply is controllable unlike traditional emergency oxygen systems. Additionally or alternatively, the oxygen enriched air 254 may be fed to air distribution subsystem 211 to enhance the oxygen content of the air in cockpit 160 and/or cabin 170. One technical benefit is that the air quality on aircraft 100 may be enhanced.

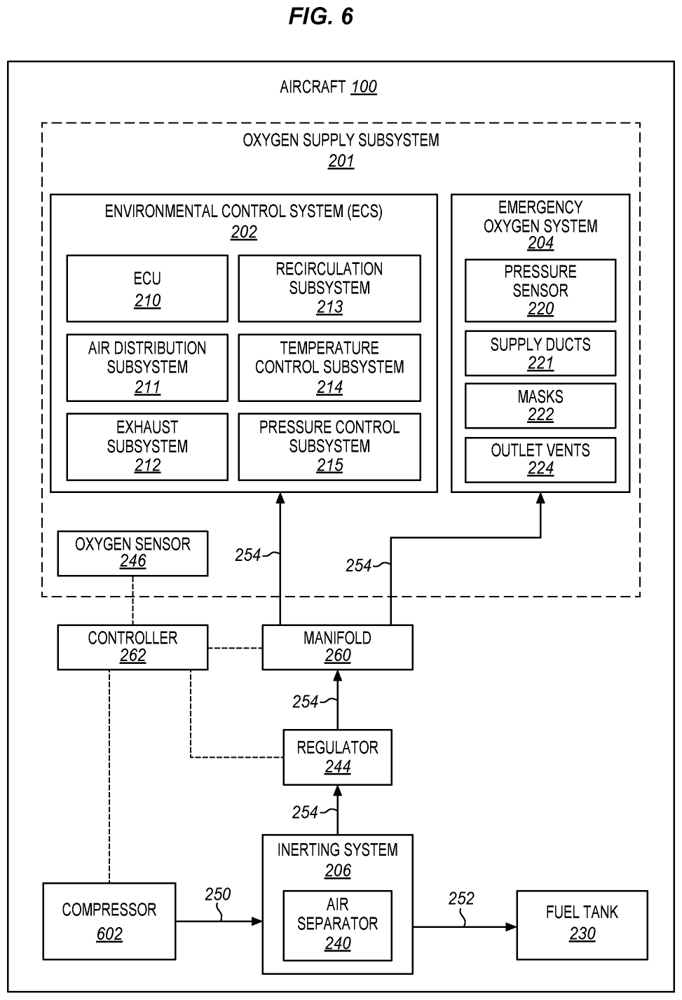

FIG. 6 is a schematic diagram of aircraft 100 in another illustrative embodiment. In this embodiment, air separator 240 of inerting system 206 receives pressurized air stream 250 from a compressor 602 instead of a compressor stage of engine 150. Compressor 602 is an auxiliary device that generates pressurized air, and may be electrical, hydraulic, pneumatic, etc. For example, a Boeing 787 may include an electric-driven compressor that supplies a pressurized air stream to inerting system 206 instead of using bleed air from an engine. Controller 262 may control compressor 602 to regulate the air that is fed to air separator 240.

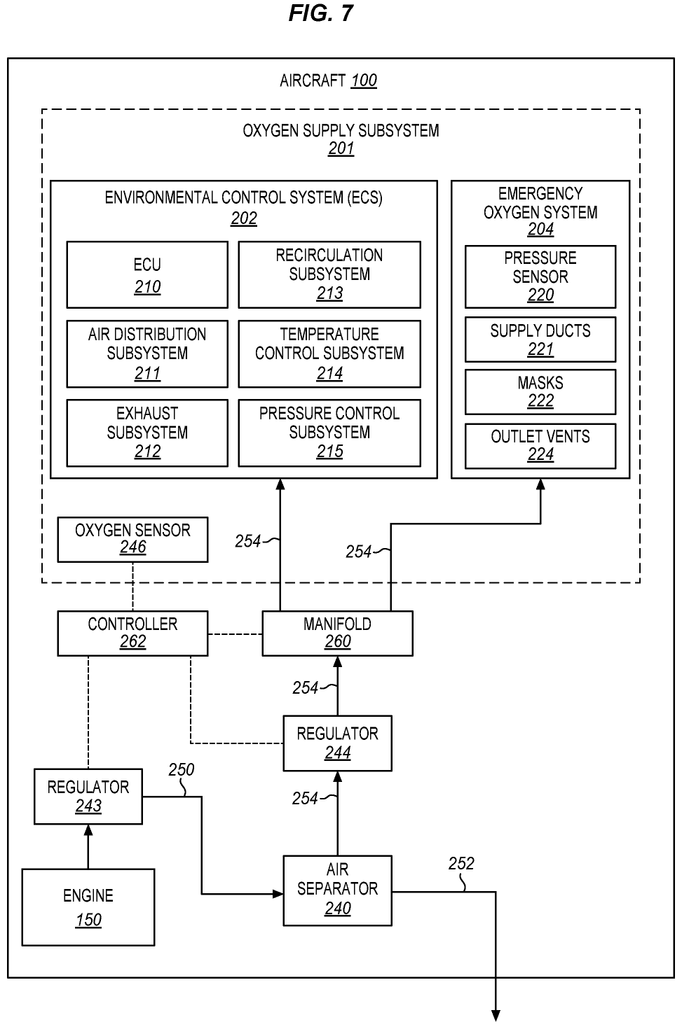

FIG. 7 is a schematic diagram of aircraft 100 in another illustrative embodiment. In this embodiment, aircraft 100 includes a stand-alone air separator 240, which is separate or independent from an inerting system. Air separator 240 receives the pressurized air stream 250 from an engine 150 of aircraft 100 as bleed air. Air separator 240 separates the pressurized air stream 250 into an inert gas 252 and oxygen enriched air 254. Air separator 240 feeds the oxygen enriched air 254 to an oxygen supply subsystem 201 through regulator 244, and dumps the inert gas 252.

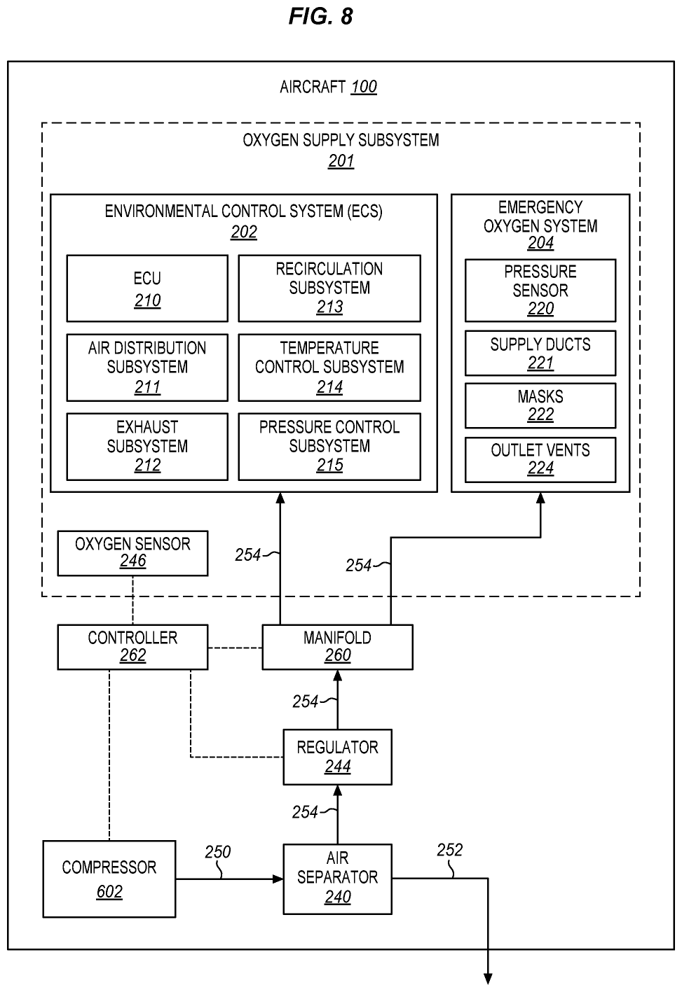

FIG. 8 is a schematic diagram of aircraft 100 in another illustrative embodiment. In this embodiment, aircraft 100 again includes a stand-alone air separator 240. Air separator 240 receives the pressurized air stream 250 from a compressor 602 instead of a compressor stage of engine 150.

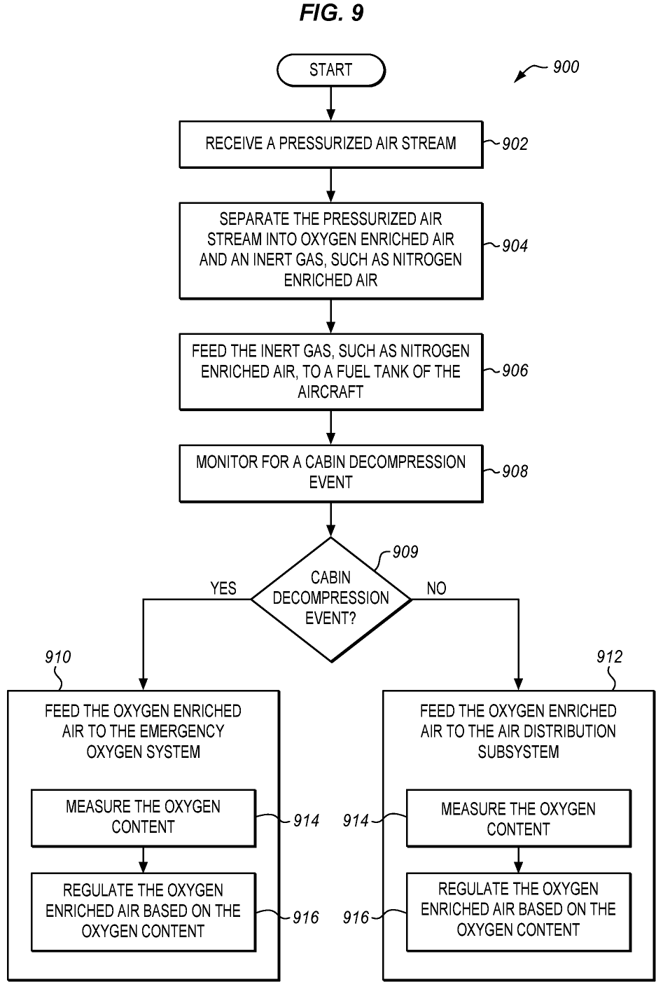

FIG. 9 is a flow chart illustrating a method 900 of supplying oxygen enriched air to an aircraft in an illustrative embodiment. The steps of method 900 will be described with respect to aircraft 100 of FIG. 2 or 6, although one skilled in the art will understand that the methods described herein may be performed on other types of aircraft. The steps of the methods described herein are not all inclusive and may include other steps not shown. The steps for the flow charts shown herein may also be performed in an alternative order.

Air separator 240 on aircraft 100 receives a pressurized air stream 250 (step 902). For example, air separator 240 may receive the pressurized air stream 250 as bleed air from an engine 150 of aircraft 100 (see FIG. 2). In another example, air separator 240 may receive the pressurized air stream 250 from a compressor 602 on aircraft 100 (see FIG. 6). Air separator 240 separates the pressurized air stream 250 into oxygen enriched air 254 and an inert gas 252, such as nitrogen enriched air (step 904). Air separator 240 feeds the inert gas 252 to a fuel tank 230 of aircraft 100 (step 906). This assists in flammability reduction by replacing the air in fuel tank 230 with the inert gas.

The oxygen enriched air 254 may be reused in an oxygen supply subsystem 201 of aircraft 100. For instance, pressure sensor 220 (and/or an associated controller) monitors for a cabin decompression event (step 908). When pressure sensor 220 detects a cabin decompression event on aircraft 100 (e.g., cabin altitude exceeds a threshold), manifold 260 feeds the oxygen enriched air 254 from air separator 240 to emergency oxygen system 204 (step 910). When there is no cabin decompression event, manifold 260 may feed the oxygen enriched air 254 to air distribution subsystem 211 (step 912). In either case, oxygen sensor 246 may measure the oxygen content in emergency oxygen system 204 and/or air distribution subsystem 211 (step 914), and regulator 244 may regulate the oxygen enriched air 254 fed to emergency oxygen system 204 and/or air distribution subsystem 211 based on the oxygen content (step 916).

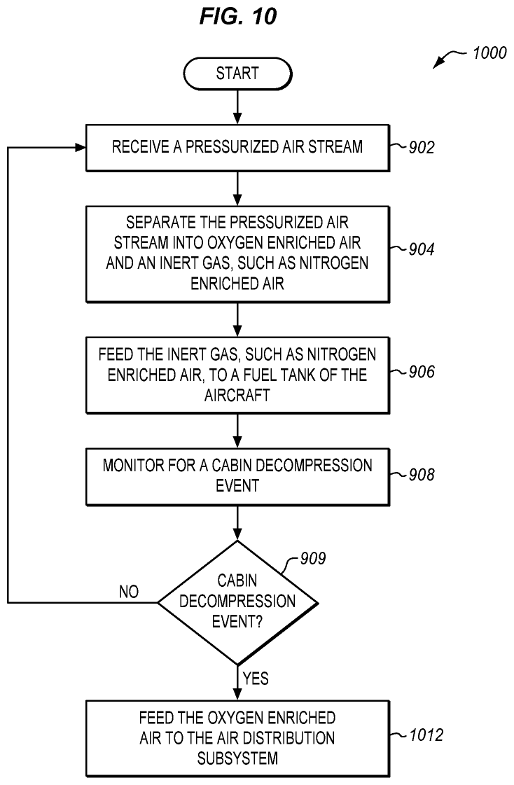

FIG. 10 is a flow chart illustrating another method 1000 of supplying oxygen enriched air to an aircraft in an illustrative embodiment. Steps 902-909 of method 1000 are similar to that described above in FIG. 9. When pressure sensor 220 detects a cabin decompression event on aircraft 100, manifold 260 feeds the oxygen enriched air 254 from air separator 240 to air distribution subsystem 211 (step 1012). Thus, the oxygen concentration in cabin 170 may be enriched by the oxygen enriched air 254 during a cabin decompression event. Step 1012 may be performed concurrently with step 910 of method 900, or may be performed in place of step 910.

Methods 900-1000 advantageously use the “waste” oxygen from air separator 240 for emergency oxygen system 204 and/or air distribution subsystem 211. Thus, traditional chemical oxygen generators and gaseous manifolds may not be needed for a cabin decompression event. Also, methods 900-1000 may use the “waste” oxygen from air separator 240 to supplement the air delivered to cabin 170 by air distribution subsystem 211 to improve air quality in aircraft 100.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope is not limited to those specific embodiments. Rather, the scope is defined by the following claims and any equivalents thereof.

1. An aircraft comprising:
an oxygen supply subsystem configured to supply oxygen to a cabin of the aircraft; and
an air separator configured to receive a pressurized air stream, to separate the pressurized air stream into oxygen enriched air and an inert gas, and to feed the oxygen enriched air to the oxygen supply subsystem.

2. The aircraft of claim 1 wherein:
the air separator is part of an inerting system configured to feed the inert gas to a fuel tank of the aircraft.

3. The aircraft of claim 1 wherein:
the oxygen supply subsystem comprises an emergency oxygen system; and
the air separator is configured to feed the oxygen enriched air to the emergency oxygen system.

4. The aircraft of claim 3 further comprising:
a pressure sensor configured to detect a cabin decompression event on the aircraft; and
a manifold configured to feed the oxygen enriched air from the air separator to the emergency oxygen system in response to the cabin decompression event.

5. The aircraft of claim 4 wherein the emergency oxygen system includes:
masks configured to automatically deploy in response to the cabin decompression event.

6. The aircraft of claim 4 wherein the emergency oxygen system includes:
outlet vents configured to supply oxygen to particular regions within the cabin in close proximity to seats in response to the cabin decompression event.

7. The aircraft of claim 1 wherein:
the oxygen supply subsystem comprises an air distribution subsystem; and
the air separator is configured to feed the oxygen enriched air to the air distribution subsystem.

8. The aircraft of claim 7 further comprising:
a pressure sensor configured to detect a cabin decompression event on the aircraft; and
a manifold configured to feed the oxygen enriched air from the air separator to the air distribution subsystem in response to the cabin decompression event.

9. The aircraft of claim 1 further comprising:
an oxygen sensor configured to measure oxygen content at the oxygen supply subsystem; and
a regulator configured to regulate the oxygen enriched air fed to the oxygen supply subsystem based on the oxygen content.

10. The aircraft of claim 1 wherein:
the pressurized air stream comprises bleed air from an engine of the aircraft.

11. The aircraft of claim 1 wherein:
the pressurized air stream comprises compressed air from a compressor on the aircraft.

12. An aircraft comprising:
an emergency oxygen system configured to automatically supply oxygen to a cabin of the aircraft when a cabin altitude exceeds a threshold;
an inerting system configured to receive a pressurized air stream, to separate the pressurized air stream into oxygen enriched air and nitrogen enriched air, and to feed the nitrogen enriched air to a fuel tank of the aircraft; and
a manifold configured to feed the oxygen enriched air from the inerting system to the emergency oxygen system when the cabin altitude exceeds the threshold.

13. The aircraft of claim 12 further comprising:
an air distribution subsystem configured to distribute conditioned air through the cabin via one or more overhead ducts;
wherein the manifold is configured to feed the oxygen enriched air from the inerting system to the air distribution subsystem when the cabin altitude is below the threshold.

14. The aircraft of claim 13 further comprising:
an oxygen sensor configured to measure oxygen content in at least one of the emergency oxygen system and the air distribution subsystem; and
a regulator configured to regulate the oxygen enriched air fed to the at least one of the emergency oxygen system and the air distribution subsystem based on the oxygen content.

15. The aircraft of claim 12 wherein:
the pressurized air stream comprises bleed air from an engine of the aircraft.

16. The aircraft of claim 12 wherein:
the pressurized air stream comprises compressed air from a compressor on the aircraft.

17. A method comprising:
receiving a pressurized air stream at an air separator on an aircraft;
separating the pressurized air stream into oxygen enriched air and nitrogen enriched air at the air separator;
feeding the nitrogen enriched air to a fuel tank of the aircraft;
detecting a cabin decompression event on the aircraft; and
feeding the oxygen enriched air to an emergency oxygen system in response to the cabin decompression event.

18. The method of claim 17 further comprising:
feeding the oxygen enriched air to an air distribution subsystem of the aircraft when the cabin decompression event is not detected.

19. The method of claim 18 further comprising:
measuring oxygen content in at least one of the emergency oxygen system and the air distribution subsystem; and
regulating the oxygen enriched air fed to the at least one of the emergency oxygen system and the air distribution subsystem based on the oxygen content.

20. The method of claim 17 further comprising:
feeding the oxygen enriched air to an air distribution subsystem of the aircraft in response to the cabin decompression event.
